(19) United States
(12) Patent Application Publication
(10) Pub. No.: US 2014/0272832 A1
(43) Pub. Date: Sep. 18, 2014

(54) PATIENT NOTE SCORING METHODS, SYSTEMS, AND APPARATUS

(71) Applicant: National Board of Medical Examiners, Philadelphia, PA (US)

(72) Inventors: Ruslan Mitkov, Redditch (GB); Le An Ha, Wolverhampton (GB); Richard James Evans, Wolverhampton (GB); Georgiana Cristina Marsic, Bedford (GB); Su Baldwin, Philadelphia, PA (US); Brian Clauser, Media, PA (US); Ronald J. Nungester, Berwyn, PA (US)

(73) Assignee: NATIONAL BOARD OF MEDICAL EXAMINERS, PHILADELPHIA, PA (US)

(21) Appl. No.: 14/204,546

(22) Filed: Mar. 11, 2014

Related U.S. Application Data
(60) Provisional application No. 61/779,321, filed on Mar. 13, 2013.

(51) Int. Cl. G09B 5/00

(52) U.S. Cl. CPC G09B 5/00
USPC 434/219

(57) ABSTRACT

Aspects of the invention include methods of generating models for scoring patient notes. The methods include receiving a sample of patient notes, extracting a plurality of ngrams from the sample of patient notes, clustering the plurality of extracted ngrams that meet a similarity threshold into a plurality of lists, identifying a feature associated with each of the plurality of lists based on the ngrams in that list and designating at least one ngram in each list as evidence of the feature associated with that list. The identified features and designated ngram are stored in models for scoring patient notes.

### CROSS-REFERENCE TO RELATED APPLICATION(S)

This application claims priority to U.S. Provisional application Ser. No. 61/779,321, entitled “PATIENT NOTE SCORING METHODS, SYSTEMS, and APPARATUS, filed on Mar. 13, 2013, the contents of which are incorporated fully herein by reference.

### FIELD OF THE INVENTION

The invention relates to the field of automated scoring of patient notes.

### BACKGROUND OF THE INVENTION

Patient notes are used in the medical field to record information received from a patient during consultations with medical professionals. Developing patient note taking skills and assessing student readiness to enter into the medical practice is vital. There is a need for more efficient ways to develop patient note taking skills.

### SUMMARY OF THE INVENTION

Aspects of the invention include methods of generating models for scoring patient notes. The methods include receiving a sample of patient notes, extracting a plurality of ngrams from the sample of patient notes, clustering the plurality of extracted ngrams that meet a similarity threshold into a plurality of lists, identifying a feature associated with each of the plurality of lists based on the ngrams in that list and designating at least one ngram in each list as evidence of the feature associated with that list. The identified features and designated ngram are stored in models for scoring patient notes.

Further aspects of the invention include methods of scoring patient notes. The methods include producing a scoring model based on at least one feature and acceptable evidence that indicates the at least one feature in a patient note, determining for each patient note in a set of patient notes whether at least one piece of acceptable evidence that indicates the at least one feature is present in each patient note, and scoring each patient note in the set of patient notes based upon the determined presence of acceptable evidence in each patient note.

### BRIEF DESCRIPTION OF THE DRAWINGS

The invention is best understood from the following detailed description when read in connection with the accompanying drawings, with like elements having the same reference numerals. This emphasizes that according to common practice, the various features of the drawings are not drawn to scale. On the contrary, the dimensions of the various features are arbitrarily expanded or reduced for clarity. Included in the drawings are the following figures:

FIG. 1 is a flowchart of steps in a method for generating a scoring model in accordance with aspects of the invention;

FIG. 2 is a flowchart depicting ngram extraction according to aspects of the invention;

FIG. 3 depicts a selection interface in accordance with aspects of the invention;

FIG. 4 is a flowchart of steps in a method for generating a scoring model in accordance with aspects of the invention;

FIG. 5 is a flowchart of steps for scoring a set of patient notes according to aspects of the invention;

FIG. 6 is a graph depicting learning curve correlation according to aspects of the invention;

FIG. 7 is a chart of statistical data calculated based on scoring methods according to aspects of the invention; and

FIG. 8 is a diagram of a system in accordance with aspects of the invention.

### DETAILED DESCRIPTION OF THE INVENTION

Writing patient notes is one of the basic activities that medical students, residents, and physicians perform. Patient notes are composed by medical professionals after a patient encounter in a clinic, office, or emergency department. They are often considered to comprise four parts, denoted Subjective, Objective, Assessments, and Plan (as a result they are often called SOAP notes). Patient notes are the main tools used by medical professionals to communicate information about patients to colleagues. The ability to effectively write patient notes is one of the key skills used to assess medical students before being licensed to practice medicine. The Step 2 Clinical Skills (“CS”) assessments which form part of the United States Medical Licensing Examination (“USMLE”) directly involve test takers in simulated patient encounters involving standardized patients and require them to take a history, perform a physical examination, determine differential diagnoses, and then write a patient note based on their observations. The patient notes compiled by examinees are expected to contain four elements, following the structure of SOAP notes: Pertinent History (subjective), Physical Examination (objective), Differential Diagnoses (assessments), and potential Diagnostic Studies (plan). Section 3 details the characteristics of these elements.

The notes composed by test takers are then rated by trained physicians. For each case, a scoring guide is made available to raters to facilitate manual scoring of these notes. In the current context, scoring involves assigning a score from 1 to 9 to each note. So far, only trained physicians have been involved in scoring notes. Scoring is a time intensive process, not only in terms of the rating itself, but also due to the case-specific training required. As a result, a Computer-Assisted Patient Note Scoring system (“CAPTNS”), has been developed. CAPTNs uses Natural Language Processing (“NLP”) technology to facilitate rating by suggesting important features that should be present in a note, and lists of textual evidence (ngrams) whose occurrence in a note implies that the test taker has included a particular feature in that note. The term acceptable evidence is used to denote this type of linguistic material. Information on the occurrence of features suggested by CAPTNs and the acceptable evidence for those features may then used to produce feature vectors for each note, which, in turn, may be used to build automated rating models. The final score assigned to a patient note may be derived from information about the presence or absence of the identified features in the note.

Patient notes refer to records of individual physician-patient encounters. They are parts of problem-oriented medical records, whose purpose is to preserve the data in an easily accessible format that encourages on-going assessment and revision of health care plans by all members of the health care team. They are used to communicate information on individual encounters among practitioners. Patient notes are sometimes called SOAP notes, due to the fact that they should consist of four elements: subjective, objective, assessment, and plan. These four elements may have different names, depending on the requirements. In USMLE Step 2 CS, they are translated into History, Physical Examinations, Differential diagnoses, and Diagnostic Studies. USMLE states that such notes are similar to those which physicians have to compose in different settings.

In general for patient notes completed by physicians, the History part is expected to contain the chief complaint(s) of the patient, further information on the chief complaint(s), which can include information about its onset, anatomical location, duration, its character, factors that can alleviate it, or about its radiation (locations that it also affects). The History should also include a review of any significant positives and negatives (the presence or absence of other factors relevant to the diagnosis), details of medications taken, and pertinent family, social, and medical history. The rule of thumb is that physicians should record any information that they deem important for the diagnosis and treatment plan of the case. This allowance means that several alternate structures of the History element may be acceptable, and, in the case of USMLE, the scoring guidelines do not channel test-takers toward any specific structure, as long as important information is recorded. The guidelines do not prescribe the vocabulary and writing styles to be used in the notes either, as long as they are understandable by fellow physicians. Although this is a flexible approach, and similar to the philosophy of the Unified Medical Language System (“UMLS”), which allow multiple world points of view, it creates challenges in processing patient notes. Specifically the processing engines have to be flexible enough to accept considerable variability in vocabulary and style.

The language used in patient notes written by USMLE Step 2 CS test takers was analyzed. In the current context, the test takers are training to be licensed physicians and test administrators consider the notes to be similar to those composed by physicians after their encounters with patients in different clinical settings. It is thus hypothesized that the sub-language to which these notes belong is that to which a wide variety of other types of patient note belong. The aim of the invention is to understand the linguistic features, and to guide the development of the NLP engine accordingly.

Within the four elements of the note, examinees employ free text. The History field is used to summarize information received by interviewing the patient during the encounter. It contains information about different aspects of the history, such as the history of the present illness; medical, surgical, family, and sexual histories; or a summary of the patient's social life/lifestyle. It has been observed that test-takers use several ways to structure these aspects. For the purpose of linguistic analysis, the discourse structure of the History field is considered to comprise 11 possible segments:
1. chief complaint,
2. history of the present complaint,
3. significant positives,
4. significant negatives,
5. whether fever/chill presents,
6. whether chest pain/SOB (shortness of breath) presents,
7. any GI (gastro-intestinal) symptoms,
8. medical history,
9. social history,
10. family history, and
11. medicines.

Each of these segments can be recognized by a set of discourse markers. For example, the chief complaint often appears under the heading “CC:”, or in the pattern “the patient/he/she complains of”. Significant negatives (indications of the absence of factors) are often marked with “Denies”, or “(−)”. These discourse markers will be utilized to classify features that will help provide some context to reviewers. It is noted that the presence and the order of occurrence of the eleven listed segments of the History varies over notes of equal quality.

Information presented in the Physical examination, which summarizes findings obtained during the physical examination of standardized patients by test takers, is more structured. Each of the procedures carried out and the findings observed are often preceded in the note by a heading, such as Vital (for Vital signs), GA (for general appearance), and so on. For the purpose of linguistic analysis, the Physical Examination element is considered to comprise ten parts:
1. Vital signs,
2. General appearance,
3. HEENT (Head, Ears, Eyes, Nose and Throat),
4. Neck,
5. Lung,
6. Cardiovascular,
7. Abdomen,
8. Extremities,
9. Skin, and
10. Neurological

As in the case of the History, the presence and the order of occurrence of the ten listed segments of the Physical Examination varies even among notes of equal quality.

Differential diagnoses and Workups are lists of free text items indicating possible diagnoses derived from findings observed in the Physical Examination and History and tests intended to investigate the possible diagnoses. As a result, each element of the lists are considered separately within these segments rather than comprising discourse sub-units within them.

In patient notes, sentences with standard structure, typical of other types of written English, rarely appear. When they do, they usually occur in the History part of the note. Other “sentences” often appear incomplete, with frequent elision of information that readers are expected to infer pragmatically. As a result, such sentences often comprise lists of either positive or negative significances (1), short statements (2), or a combination of different structures (3). These examples are all extracted from the same note.

(1) Denies melena, hematochezia, hematuria, dysuria, easy bruising/bleeding, difficulty initiating urination, fever, or weight loss

(2) PSH: kidney operation 26 yrs ago

(3) SH: lives with wife, worked at same company 30 yrs, no tobacco, occasionally drinks 6 pack/day.

Empirical analysis indicates that the syntactic form by which these facts are expressed does not affect the scores, and as a result, syntactic analysis is not performed by CAPTNS and does not contribute to the computer-assisted scoring methodology. Instead, the use of simple heuristics and pattern matching are motivated for the purpose of extracting information from the notes.

The vocabulary of the patient notes can be considered the most difficult problem to address, from the NLP point of view. There are three main issues that the NLP engine needs to address: the use of abbreviations, the use of both specialized medical terms and everyday language, and the occurrence of typographical errors.

Abbreviations are used extensively and there is variation in the choice of abbreviation among authors. The notes assessed demonstrate the use of both conventional abbreviations, and the ad-hoc invention of abbreviated forms.

To illustrate, consider (4) and (5), which present the findings of two types of examination presented in patient notes composed by two different examinees.

(4) Cardiac: RRR, no MRG pulm: ctab.

(5) Pulm: clear to auscultation bilaterally

CVS: regular rate and rhythm, no murmurs, rubs, or gallops

The two notes differ in the choice of reference to the examination. The reference in (4) is more specific than that in (5), denoting cardiac examination as opposed to examination of the cardiovascular system (CVS). In both cases, identical findings are noted. In (4), regular rate and rhythm is abbreviated as RRR, murmurs rubs and gallops is abbreviated as MRG, and clear to auscultation bilaterally is abbreviated as ctab. In general, for notes composed in this context, the guidelines provided to Step 2 CS test takers encourage the use of abbreviation in patient notes (the guidelines provide a table of standard abbreviations that examinees might use and imply that more may be employed where necessary), but strict adherence to a particular methodology for abbreviation is not expected. This kind of heterogeneity in the language of patient notes is a characteristic of those produced by medical professionals in their daily work.

Further evidence is provided by the variety of means used to express the fact that a patient is alert and oriented to person, place and time (i.e. is aware of who they are, where they are, and the current day/date/time). It can be entered as: A/O * 3; A/O x 3; AxOx3; AAOx3; aao x 3; aaox3; AAO X 3; A&Ox3; A+Ox3; aao x 3; ao x 3; or AO to person place date, etc. Similar heterogeneity is apparent in references to examinations. For example, examination of the extremities may be indicated by Extrem-; Extrems; extreme; Extr; ext; Ext; LE; etc.

One additional method of abbreviation is the use of the hyphen in patient notes. It is often used to separate values from attributes (e.g. bp-; VS-WNL; abd-soft); ranges of anatomical locations (e.g. CN II-XII; CN's 2-12; CN2-12), measures (4-5 lbs), or frequencies (e.g. 1-2×/month); to modify findings (CTA-B); and finally in its traditional role to create compound modifiers and compound nouns (y-o; 6-pack).

Spelling mistakes and typographical errors are very common in patient notes (e.g. asymetry; apparetn; alteast for at least; AAAx3 for AAOx3; bowie movements; esophogastroduodenoscopy for esophagogastroduodenoscopy; hennt for heent; surgicla; quite smoking; anemai for anemia, etc.), and scorers are instructed to tolerate these typos as long as the meaning of the note is clear. As a result, the NLP engine is expected to process this type of ill-formed input.

Finally, it is noted that medical and everyday terms are used interchangeably in the sample of patient notes (e.g. rhinorrhea: runny nose, Blood in stool: melena or hematochezia (clinically melena and hematochezia are different, with melena being a sign of hematochezia, but the analysis of the notes and scores indicate that both of them are acceptable), etc.). The NLP engine is therefore designed to be equally effective when presented with such stylistic variation.

The empirical analysis suggests that the language used in patient notes is unique, and as well as offering a challenge to existing tokenization systems, other linguistic tools such as part-of-speech taggers, and parsers are unlikely to be effective. Further, the linguistic features commonly used in other computer-assisted scoring systems will not be suitable for the task. Instead, a new method needs to be developed to deal effectively with the language of patient notes.

Investigation of the contents of notes and their corresponding scores revealed that there is a correlation between the scores assigned to notes and the occurrence of a number of distinctive features (important facts) that are present in them. For example, given the case of a 52 year-old man with significant depression, the distinctive features are weight loss, appetite, low energy and interest, low libido, diarrhea, constipation, no stool blood, normal family history, no chronic illness, medication, ETOH, CAGE, and suicidal ideation. These features, in turn, can be expressed in various ways, for example weight loss as wt loss, weigh loss, etc. The empirical analysis of such example cases led to the formulation of a strategy for computer-assisted patient note scoring in which scores are assigned automatically on the basis of the occurrence in the notes of a set of features specific to each case. The requirement to build specific set of features for each case can pose a barrier to computer-assisted scoring. The benefit of computer-assisted scoring is inversely proportional to the time required to build each set of features. One method by which this obstacle can be negotiated is to automate the process of determining both distinctive features and the sets of acceptable evidence that confirm the presence of that distinctive feature in a patient note, as far as possible. The invention automatically extracts a suggested list of features (e.g. weight loss) and acceptable evidence (e.g. wt loss, weigh loss, etc) that confirms the presence of that feature in a note. This list is then reviewed by human experts. The process of automatically producing the suggested lists of features and acceptable evidence, as well as the human review of these lists is described below.

Referring to FIG. 1, a flowchart 10 of steps for generating a scoring model for scoring patient notes is shown according to aspects of the invention. One of skill in the art from the description herein will understand that some of the steps of flowchart 10 may be omitted or performed in alternative order to effectuate the invention.

At block 100, a sample of patient notes is received. As used herein, a “sample” of patient notes refers to a number of patient notes that are used to generate a scoring model for scoring patient notes. In an embodiment, the sample of patient notes is not scored in subsequent scoring steps. The number of patient notes in the sample may be any number of patient notes adequate to generate the scoring model. In an embodiment, the sample of patient notes includes about 300 patient notes. In one embodiment, the sample of patient notes includes about 30% of all patient notes generated in a study. The sample of patient notes may be received by a computer processor to be further analyzed and processed in generating the scoring model.

At block 102, ngrams are extracted from the sample of patient notes. The generation of lists of features and evidence associated with the features is based on identification of ngrams rather than other linguistic units due to the unique nature of patient notes. As used herein, “ngrams” refers to units of language in a patient note. Patient notes typically include abbreviations, spelling mistakes, incomplete sentences, etc. These characteristics can create difficulty for other linguistic processes such as part-of-speech tagging, parsing, etc.

At block 104, tokenization is performed to separate the contents of the patient notes into units (excluding sentence tagging), and the units that can be reliably identified are ngrams. In an embodiment, the unit length of each ngram is 1≦n≦5. Other suitable unit lengths will be understood by one of skill in the art from the description herein. In one embodiment, the text of patient notes is split into units/chunks using a set of boundary markers that often signify the boundary of a fact, including semicolons, commas, and slashes. Each unit/chunk is treated as an ngram. Referring to FIG. 2, a flowchart 20 depicts a sample of notes 200 being tokenized 202, and then converted into ngrams 204 with a unit length of 2.

At block 106, linguistic filters are applied to the ngrams. The filtering process is intended to ensure that the lists of features and evidence presented to reviewers are as readable as possible to avoid adverse effects on them. Such filters are applied to remove ngrams that consist of sequences of function words, punctuation, incomplete syntactic constituents, etc. In one embodiment, the ngrams are cross-referenced with a list of ngrams known to be not useful (e.g., “and”, “or”, “not”, “patient”, etc.). The ngrams may be cross-referenced with a list of known to be not useful starts that indicate incomplete syntactic constituents. For example, those that start with “or” or “and” tend to indicate incomplete syntactic constituents (e.g., “or smoking,” “and fever,” etc.). The ngrams may be cross-referenced with a list known to be not useful finishes that indicate incomplete syntactic constituents. For example, those that end with “and better” and “described as” tend to indicate incomplete syntactic constituents (e.g., “exercise and better,” “pain described as,” etc.). Other suitable linguistic filtering processes will be understood by one of skill in the art from the description herein. Referring back to FIG. 2, ngrams 206 represent some of the ngrams remaining from the sample of notes 200 after tokenization and application of filters.

At block 108, the remaining ngrams are extracted and then clustered into a plurality of lists. Blocks 110-122 describe sub-steps to the clustering step of block 108 in accordance with aspects of the invention. Similarities between ngrams that may allow them to be grouped into a single conceptual unit, feature, and/or other information, are then identified and clustered by calculating the similarity between the ngrams. The similarity between two ngrams may be calculated using a combination of character-based edit-distance (to cover typos and spelling variations), Wordnet edit distance (to account for general language variation), and UMLS edit distance (to deal with medical language variation).

In an embodiment, character based edit distance is calculated at block 112. Character-based edit distance may be calculated as the Levenshtein Distance between two ngrams, in which edits are performed at the character level.

At block 114, edit distance (e.g., Wordnet edit distance) between ngrams is calculated. Wordnet similarity may be calculated based on Levenshtein distance between two ngrams, in which edits are performed at the word level, and the cost of replacement of one word by another is equal to the normalised distances between the two words according to Wordnet.

In one embodiment, Wordnet similarity S_{WN}(N₁,N₂), between ngrams N₁ and N₂, is calculated as:

S_{WN}(N₁,N₂)=W_{ED}(N1,N₂)/Max(Length(N₁),Length(N₂))

Here, Length(Nᵢ) is the number of words in ngram Nᵢ. W_{ED}(N1,N₂) is calculated as the (weighted) number of word-level edit operations (insertion, deletion, or substitution) needed to convert N₁ into N₂. The weight of the substitution operation of word W₁ by word W₂ is calculated as 1−Wₛ(W₁,W₂). The weights of the insertion and deletion operations are both 1. The Wordnet similarity, Wₛ (W₁,W₂), between words W₁ and W₂, is calculated as:

Wₛ(W₁/W₂)=1 if W₁=W₂ or if W₁ and W₂ are synonyms

Otherwise:

Ws(W₁,W₂)=1/(1+Min(Ds(W₁/W₂)))

Here, Min(Ds(W₁,W₂)) is the minimum path length from W₁ to W₂ that is formed by relations between senses encoded in WordNet.

Example:

N₁=“sick contacts”; N₂=“ill contacts”

Min(Ds(“sick”, “ill”))=0; because “sick” and “ill” share the sense 302541302 (affected by an impairment of normal physical or mental function). This means that Wₛ(“sick”, “ill”)=1; W_{ED}(“sick contacts”, “ill contacts”)=0; and S_{WN}(“sick contacts”, “ill contacts”)=0.

In an embodiment, the Unified Medical Language System (UMLS) similarity between ngrams is calculated at block 116. Calculation of UMLS similarity exploits the concept unique identifiers (CUI) assigned to every entry in the UMLS Metathesaurus vocabulary database, the contents of which are incorporated herein by reference.

In one embodiment, UMLS similarity, S_{UMLS}(N₁/N₂), between ngrams N₁ and N₂, is calculated as follows:

S_{UMLS}(N₁,N₂)=1 if either N₁ or N₂ does not contain any string that can be found in UMLS.

Otherwise:

S_{UMLS}(N₁,N₂)=Min(N_{ED}CUI(WholeCUI(N₁),WholeCUI(N₂)),N_{ED}CUI (SplitCUI(N₁),WholeCUI(N₂),N_{ED}CUI(WholeCUI(N₁),SplitCUI(N₂),N_{ED}CUI (SplitCUI(N₁),SplitCUI(N₂)))

The term SplitCUI(N₁) is derived by replacing each word in N₁ with its CUI; Any word that does not have a CUI remains unchanged; if a word has multiple CUIs, it is replaced by that list of CUIs.

The term WholeCUI(N₁) is produced by replacing each word in the longest matching string in N₁ with its CUI. N_{ED}CUI (S₁,S₂) is the normalised edit distance between the two strings S₁ and S₂, and is calculated as

N_{ED}CUI(S₁,S₂)=E_{CUI}(S₁,S₁)/(2×Max(Length(S₁),Length(S₂))

Here, E_{CUI}(S₁,S₂) is calculated as the weighted number of word level operations (insertion, deletion, and substitution) needed to convert S₁ into S₂. The weights of insertion and deletion operations are both 1. The weight of the substitution of word W₁ by word W₂ is 0 if W₁ contains CUIs of W₂ or vice versa (which means that W₁ can mean W₂). This weight it will be set to 2 if both W₁ and W₂ are lists of CUIs, but they do not overlap. This is an empirical setting, the rationale being that if both W₁ and W₂ are medical terms, but do not share CUIs, they are presumed to be more dissimilar than would be the case if W₁ were a medical term and W₂ was not (and vice versa), in which case the weight will be set to 1.

Example:

N₁=“viral pneumonia”

N₂=“atypical pneumonia”

WholeCUI(N₁)=C0032310(“viral pneumonia” CUI is C0032310)

WholeCUI(N₂)=C1412002(“atypical pneumonia” CUI is C1412002)

SplitCUI(N₁)=C0521026C0032285 (“viral” CUI is C0521026; “pneumonia”: C0032285)

SplitCUI(N₂)=C0205182C0032285 (“atypical” CUI is C0205182)

N_{ED}CUI(WholeCUI(N₁),WholeCUI(N₂))=1

N_{ED}CUI (WholeCUI(N₁),SplitCUI(N₂))=0.75

N_{ED}CUI (SplitCUI(N₁),WholeCUI(N₂))=0.75

N_{ED}CUI (SplitCUI(N₁),SplitCUI(N₂))=0.5

S_{UMLS}(N₁,N₂)=0.5

At block 118, syntactic similarity may be calculated using bag-of-words similarity. For example, there is similarity between “decreased appetite” and “appetite is decreased.”

The combination of similarities between ngrams calculated at blocks 112-118 enables recognition of orthographic, lexical, syntactic, and semantic variants, and cluster together ngrams whose surface forms are different but which have identical meanings. For example, decreased appetite may be grouped with decrease in appetite (syntactic variation), decreased appetite (orthographic variation), poor appetite (semantic variation), and anorexia (lexical variation). One of skill in the art will recognize many combinations of calculations can be performed to assess the similarity between ngrams from the description herein.

At block 120, it is determined whether the similarity between ngrams meets a similarity threshold. It is contemplated that such a determination against a similarity threshold may be made after each of the calculations performed at steps 112, 114, 116, and/or 118. In an embodiment, the similarity threshold is adjustable. The extent of the adjustment will depend on the nature of the application. For example, to determine what percent of patient notes contain “chest pain” as a symptom, the similarity threshold for two ngrams to be considered similar such that they are clustered may be set lower. As a result, the system may identify “cp,” “chestpain”, or “ch pain” as synonyms of “chest pain” but not “back pain.” For applications of the system that require higher sensitivity, the similarity threshold may be increased. For example, to identify patient notes containing “thyroid disease” as a diagnosis, one would set a higher cut-off point of similarity so that “hypothyroism” would be grouped with “thyroid disease.” Other suitable similarity threshold adjustments will be understood by one of skill in the art from the description herein.

At block 122, ngrams that meet the set similarity threshold are grouped into lists, thus completing the clustering step of block 108.

At block 124, a feature associated with each list of clustered ngrams is identified. The feature associated with the list may be identified on the basis of the number of times an ngram appears in the list. In one embodiment, the ngram that occurs most frequently is identified to denote the feature associated with the list. In an embodiment, the feature associated with an ngram that appears frequently throughout the sample of patient notes may be identified as important to the case, and subsequently selected as will be described below with respect to FIG. 4.

At block 126, ngrams in each list are designated as potential evidence of the feature associated with the list. The designated ngrams may exactly match the feature, be an alternative term for the feature, an abbreviation of the feature, a typographical error close to the feature, etc. Referring to FIG. 3, a selection interface 30 in accordance with aspects of the invention is shown. The selection interface 30 includes a pattern selection column 300. In the selection column 300, a list of features 302 are included as expandable selections. The first feature 304 listed is “dizziness.” Expanding the selection displays ngrams 306 which are potential evidence of the feature. In this example, the misspelling “dizzyness”, the alternative terms “vertigo” and “lightheadedness”, and the typographical errors “dizzines” and “dizziones” are examples of potential evidence, that, when present in a patient note, could indicate the feature of “dizziness.” In producing such a list of potential evidence, the ngrams 306 were clustered at step 108, determined to meet the similarity threshold at block 120, and grouped together in the list of ngrams 306. Furthermore, the feature of “dizziness” was identified as the feature associated with that list of ngrams 204 at block 124. In one embodiment, an ngram in a patient note which exactly matches the feature itself is also evidence indicating the feature, as will be discussed with respect to FIG. 4.

At block 128, each identified feature is categorized by the type of information each feature provides. As described above, the type of information may be related to the pertinent history, physical examination, differential diagnoses, and/or diagnostic studies. Each feature may be further categorized by information on the chief complaint, significant negatives, social history, etc. Referring back to FIG. 3, the list of features 302 is categorized under history 308 and further categorized under “further infos on Chief complaint” 310. In one embodiment, the features are linked to the segments of the patient note in which they occurred (e.g., information on the chief complaint, significant negatives, social history, etc.). Linking features to the segments of the notes in which they occurred makes an important contribution in the assessment process, helping reviewers to contextualize the features. In one embodiment, the categorization of features is performed using linguistic patterns and a bootstrapping strategy. For example, an ngram adjacent to “complain” will be classified as “chief complaint”, whereas one that follows “denies” will be included among “significant negatives”. To further improve this classification, coordinated structures are split, and each of the ngrams will be considered to belong the same class as the word in the focus position of the pattern. For example, if a note contains “denies sob, fever, chill, and chest pain”, then sob, fever, chill, chest pain are all considered significant negatives. Other suitable categorization processes will be understood by one of skill in the art from the description herein.

At block 130, the categorized features are merged. In this step, features that belong to the same type of information, which share multiple patterns, may be merged into a single feature. In this way, the list of features is further reduced and refined.

At block 132, the features, the evidence, and the categorization are stored to be presented to a human reviewer for review. This assembly of data assembled from steps 100-130 may be stored in a file for review. In one embodiment, the data is exported to an html file. In an embodiment, the data is stored in an accessible database file.

Referring next to FIG. 4, a flowchart 40 of exemplary steps to review the data assembled as described in FIG. 1 and to finalize the scoring model are shown. At block 400, a reviewer receives a file including the features, evidence, and feature classification. The file the reviewer receives may be similar to the file stored at block 132 of FIG. 1. In one embodiment, the file is readable by the reviewer and presented to the reviewer as a selection interface similar to the selection interface 30 of FIG. 3.

At block 402, features and evidence acceptable to indicate the feature are selected. In one embodiment, the feature and acceptable evidence are selected by the reviewer. Referring back to FIG. 3, the features and acceptable evidence may be selected using the selection interface 30. As described above, the feature of “dizziness” includes several options for selectable evidence, e.g., feature 304 and ngrams 306. Next to each feature 304 and each option for potential evidence are check boxes 314. The reviewer may check the box next to the feature if the feature is important for the study. Additionally, the reviewer may check the box next to each option of potential evidence the reviewer deems acceptable to indicate the presence of the feature. In the embodiment shown according to FIG. 3, the reviewer has selected “dizziness” as an important feature, and has correspondingly selected “dizziness,” “dizzyness,” “vertigo,” “lightheadedness,” and “dizzines” as acceptable evidence of the feature. The evidence “dizziones” is not selected, meaning that it is not acceptable evidence of the “dizziness” feature. As such, when a patient note is later analyzed and scored, as will be described with respect to FIG. 5, if an ngram in the patient note matches the feature or the selected acceptable evidence, it will be determined that the patient note contains the feature, and the note will be scored accordingly.

At block 404, comments are optionally added. As can be seen in the comments column 316, a Chief Complaint for this study has been identified as “strange episode,” and comments are added to indicate which evidence is acceptable to indicate the Chief Complaint.

At block 406, an automatic key file is generated. The file may be generated when the reviewer has completed the selections and comments at blocks 402 and 404. The combination of data assembled in accordance with the steps of flowchart 10 along with the selections and comment received in accordance with the steps of flowchart 40 completes the scoring model, which may be stored as a key file. The key file may be stored, e.g., in memory, for use in scoring subsequently analyzed patient notes.

Referring next to FIG. 5, a flowchart 50 of exemplary steps for scoring a set of patient notes is shown. At block 500, a scoring model is produced. The scoring model may be produced as described above with respect to FIGS. 1-4. The scoring model includes selections of features and acceptable evidence indicating the feature for which each patient note in the set of patient notes will be searched. The scoring model may be in the form of a file (e.g., key file) produced at block 406 of FIG. 4. In one embodiment, the file of the scoring model is used by an automatic annotation program to annotate patient notes and highlight the occurrence (and detect the absence) of the features. Each of the steps of flowchart 50 may be performed by the automatic annotation program.

At block 502, a set of patient notes is received. As used herein, a “set” of patient notes refers to a number of patient notes that are scored using the scoring model. In one embodiment, the “set” of patient notes does not include patient notes from the “sample” of patient notes used to generate the scoring model at FIGS. 1-4. Alternatively, the “set” of patient notes may include some or all the patient notes in the “sample” of patient notes.

At block 504, it is determined whether the feature and acceptable evidence of the feature is present in each note in the set of patient notes. The determination may be performed according to steps 506-514.

At block 506, ngrams are extracted from each patient note in the set of patient notes. The ngram extraction may be performed in a manner similar to the extraction step at block 102 of FIG. 1. In one embodiment, each patient note is tokenized and linguistic filters are applied to each patient note similarly to steps 104 and 106 of FIG. 1.

After ngrams are extracted from each patient note, it is determined whether the ngrams match the feature or acceptable evidence of the feature at block 508. The program may be configured to determine exact matches as in block 510, fuzzy matches as in block 512, or both. In embodiments where the program is configured to perform exact matching at block 510, the program confirms the presence of a feature if any acceptable evidence of it is present in the note exactly as specified in the automatic key file. In embodiments where the program is configured to perform fuzzy matching at block 512, the program confirms the presence of a feature if a number of typographical errors, general vocabulary variations and/or medical vocabulary variations of the acceptable evidence is present in each patient note. Other suitable matching techniques will be understood by one of skill in the art from the description herein.

In one embodiment, features traditionally used in automated scoring such as word counts, presentational scores, and readability scores will also be produced. Experiments undertaken while developing aspects described herein showed that presentational scores and readability scores were non-contributory in this particular application. They were therefore not exploited.

At block 514, each patient note in the set of patient notes is scored based on the presence of the feature or acceptable evidence indicating the feature. The scoring step of block 514 may be performed by representing each patient note as a vector of binary values as in block 516 and/or computing the score of each patient note with the binary vector values and a regression model at block 518.

At block 516, a file is outputted that includes each patient note represented as a vector of binary values indicating for each feature selected in the scoring model whether the feature is present or not in the note. At block 518, the outputted file is used by a linear regression program to build models based on scores assigned by human raters. Such models may be used to automatically predict scores.

According to one embodiment and in addition to linear regression models, experiments applying hierarchical learning were undertaken. In this context, raters' scores are first grouped into three classes (e.g. scores 1-2-3, 4-5-6, and 7-8-9), or five classes (e.g. 1-2, 3-4, 5-6, 7-8, and 9). Various machine learning approaches were used to classify the notes into the designated classes. The resulting classifications were used to guide the next stage of the approach in which linear regression was employed to distinguish between class members within each class that includes sufficient instances for training. These experimental settings were chosen because they provide more training data for each of the classes, and the strengths of alternate classifiers can be exploited, rather than relying solely on linear regression.

The scoring step of block 514 and an evaluation of the scoring step is now described according to one embodiment of the invention. The following embodiment is exemplary and not exclusive. Other suitable scoring techniques for each patient note in a set of patient notes will be understood by one of skill in the art from the description herein.

The evaluation setting was designed to mimic the operational context in which the amount of available training data is limited. As a result, first a sample of 300 notes was used to automatically suggest features and acceptable evidence for these features. The reviewers then examined and filtered the list, and a CAPTNS key file (as opposed to the key files intended to be used by human raters) was produced for each case. In total, CAPTNS key files for 14 cases have been produced. Each of these CAPTNS key files is then used by the automatic annotation program to produce a vector representation of each patient note characterizing a case. These vectors serve as input to linear regression and other machine learning algorithms. For each case, 8 different settings have been used (see also Table 1 for their descriptions and abbreviations), most of them relying on linear regression (only Hi makes use of other machine learning algorithms). Setting C uses all of the features and acceptable evidence suggested by CAPTNS. This helps establish the added value of human reviewers. In W, only the word counts of the History and Physical Examination parts are used. This is to establish the baseline of the scoring systems. In F, only the features and acceptable evidence selected by reviewers are used to produce the vectors for linear regression. In F+P, instead of using a generic engine that recognises Physical examinations, specific Physical Examination finding patterns were used. In W+F, word counts of History and Physical Examinations are added to the vectors produced by F. In W+F+P, word counts of History and Physical Examinations are added to the vectors produced by F+P. In Hi, the best setting of hierarchical learning is used to produce the final scores. In SF, the best features from the W+F+P set are selected using feature selection on all available data. This is to test how much we could gain if we would know beforehand the best possible set of features.

TABLE 1
Settings and their abbreviation

| Abbreviation | Description |
|---|---|
| C | The annotation vectors are produced using all of the |
| | features and evidence suggested by CAPTNS |
| W | Only history and physical examination word count are used |
| | for linear regressions |
| F | Only features selected by reviewers are used for linear |
| | regressions (no word count) |
| F + P | Only features selected by reviewers are used for linear |
| | regressions (no word count); physical examinations are |
| | case-specific rather than generic |
| Hi | |
| W + F | Features selected by reviewers plus word count are used |
| | for linear regression |
| W + F + P | Features selected by reviewers plus word count are used for |
| | linear regressions; physical examinations are case specific |
| SF | Features used in W + F + P, selected using feature selection |
| | on all of the available data |

All of the models presented above were built using 30% of all the notes that are not used to produce the feature list, and the correlations r are calculated between the scores produced by the models and those produced by human raters on the remaining 70% of the notes that were not used in building the automated scoring models, or in producing the feature files. This stringent ratio of training/testing data (30% training, 70% testing) is used to simulate the expected conditions of future system usage rather than test the regression models. We consider, as a baseline, the models built using word counts only (W). We compare the correlations between the scores produced by the models and those produced by human raters on the unseen testing data, and the correlations between the scores of two human raters (Hu) for each case. The overall results are presented in FIG. 7. The weighted mean r is calculated using Fisher's z transformation, calculating the mean z, and convert it back to mean r.

Alternative methods to produce automated scores (such as hierarchical learning), the statistical significance of the differences in r produced by each setting, the learning curves which indicate the relations between the amount of training data and r, the hypothetical effect of having access to an “ideal” set of features. We will also discuss the effect of combining features, and the reliability of using certain parameters to predict r are described below.

In addition to linear regression, the scoring problem has been approached from a classification perspective. Firstly, each potential score was considered as a class: scoring patient notes was equivalent to classifying them according to a scheme involving nine possible classes corresponding to scores ranging from 1 to 9. Since the intention was to simulate a scenario in which models are trained on a relatively low number of patient notes (30% of the available data for training), the amount of training data proved to be insufficient for the classification problem involving nine classes and with instances represented using approximately 40 features (the number of features was somewhat case-dependent). This explains the poor results achieved by several classifiers trained on 30% of the data and evaluated on the remaining 70%, with the output of the best classifier indicating an average correlation of 0.185 across all cases. In an attempt to overcome the difficulty of this high-dimensional classification problem, we experimented with hierarchically decomposing the problem by grouping neighbouring scores together. The following score groupings were experimented with:

Grouping A:
Class A1: includes scores 7, 8 and 9;
Class A2: includes scores 4, 5 and 6;
Class A3: includes scores 1, 2 and 3;

Grouping B:
Class B1: includes scores 8 and 9;
Class B2: includes scores 5, 6 and 7;
Class B3: includes scores 1, 2, 3 and 4;

Grouping C:
Class C1: includes scores 7, 8 and 9;
Class C2: includes scores 5 and 6;
Class C3: includes scores 1, 2, 3 and 4;

Grouping D: (this Grouping was Chosen to Proportionally Distribute the Number of Notes into Classes)
Class D1: includes scores 7, 8 and 9;
Class D2: includes score 6;
Class D3: includes scores 1, 2, 3, 4 and 5;

Grouping E:
Class E1: includes score 9;
Class E2: includes scores 7 and 8;
Class E3: includes scores 5 and 6;
Class E4: includes scores 3 and 4;
Class E5: includes scores 1 and 2.

Various classifiers (i.e. BayesNet, SVM, SMO, JRip, AdaBoost, J48) were evaluated on all the previously mentioned groupings with 30/70% split between training and testing data. After classification, experiments were conducted in which the classes included in each grouping were mapped to their median scores. For example, in the case of Grouping A, we mapped the class A1 to 8, the class A2 to 5, and the class A3 to 2. The correlation between scores originally provided by human raters and the scores resulting from mapping the classification output was then measured. In this context, 0.2≦r≦0.3, much more distant than the correlation between humans raters. However, given that only one score was assigned to all the instances belonging to a particular class, the correlation was unexpectedly close. Having made the initial coarse-grained classification, the second level of the hierarchical classification process was invoked in order to distinguish between scores belonging to the different classes.

After the classifiers learn to distinguish among the coarse classes situated at the top level of the hierarchy, for each class in a particular grouping, the corresponding instances are filtered on the basis of the top level classifier's prediction. The SMO (Sequential Minimal Optimization) classifier was found to be most accurate in distinguishing between the top level classes included in various groupings, and was therefore selected for the top level classification. For the lower level distinctions, Linear Regression yielded the best accuracy. However, at the second hierarchical level, Linear Regression is only applied to those classes in which there are enough instances to support an additional 30/70% split between training and testing data. Typically these are the mid-range classes (i.e. A2, B2, C2, E3), which are the most frequent ones. In this approach, the classifications provided by Linear Regression for these classes are then combined with those obtained by the SMO model applied to less frequent classes (which had previously been mapped to a single score per class, as described earlier). The correlation between human annotated scores and the scores yielded by the hierarchical classification process were calculated.

Closest correlation with human annotated scores was observed for Grouping B (Class B1: 8-9, Class B2: 5-6-7; Class B3: 1-2-3-4). These results appear in column Hi in FIG. 7. The average correlation across all cases is 0.44, almost as close as the correlation between human raters (Δr=−0.03). The results indicate that hierarchical learning does not yield results that evoke further improvements in correlation with scores assigned by human raters. These results support the hypothesis that nominal classification-based approaches are not suitable as a means of scoring patient notes, and regressions are the best method to perform the task, mainly because the set of scores obtained is ordered (e.g. score 2 is better than score 1), rather than unordered (e.g. score 2 is different from score 1).

Table 2 presents a statistical significance matrix indicating differences between the correlation of different scoring methods with human raters. If the difference between (i) the closeness of correlation of system A to human raters and (ii) the closeness of correlation of system B to human raters is sufficiently large, then the difference between A and B is considered to be statistically significant. The statistical significance scores are calculated on the basis of the Fisher transformation of r into z, followed by application of standard two tailed t-tests to those zs. The most important observations are detailed below. Firstly, models built using word count only (W) are not statistically significantly different from models built using only features and acceptable evidence suggested by CAPTNS (C). Models built using features (including features present in the PHYSICAL EXAMINATION segments of the notes) are statistically significantly different from models built using only word count, W (see column 3). This confirms that the content-based scoring methodology, when applied in isolation, is better than word count-based scoring. The next observation is that the best configuration, taking into account operational requirements (limited number of training instances) is W+F+P, which is slightly better correlated with human raters than other models, but the differences are only statistically significant for C (CAPTNS only), W (word count only), and F (features only, in which physical examinations are generic). These results are presented in row 7. This means that although use of the W+F+P setting is to be recommended, W+F is another viable option. The final observation noted here is that when “ideal” sets of features are available, the produced average z is not statistically significantly different from those of W+F, W+F+P, and Hu. This indicates that although the methodology would benefit from careful selection of features, a cost-benefit analysis comparing the time taken to find ideal sets versus the improvement obtained in r, indicates that this strategy may not be economical. Human average z, although slightly better than those of all of the models, except for W+F+P and SF (“ideal” set of features), shows statistically significant differences only with C, W, and F, and differences that are statistically significant at 0.05<p<0.1 from F+P (see row 8).

TABLE 2
Statistical significance matrix

| | C | W | F | F + P | Hi | W + F | W + F + P | Hu |
|---|---|---|---|---|---|---|---|---|
| W | N | | | | | | | |
| F | Y | N | | | | | | |
| F + P | Y | Y | N | | | | | |
| Hi | Y | Y | N | N | | | | |
| W + F | Y | Y | Y | N | N | | | |
| W + F + P | Y | Y | Y | N(.05 < p < .1) | N | N | | |
| Hu | Y | Y | Y | N(.05 < p < .1) | N | N | N | |
| SF | Y | Y | Y | Y | Y | N | N | N |

The dependency of the magnitude of correlation coefficients between different rating methods and human experts on the number of training samples available to those rating methods is now discussed. This dependency was investigated by running the same experiment, using 30, 40, 50, and 60 percent of the available data as training data, and validating on the rest of the data. This process indicated that for word count only, the average correlation coefficients stabilize at 0.32, whereas when only content features are used, the average r increases from 0.40 to 0.43. This indicates that content-based scoring benefits from more training data, whereas word-count based scoring does not (see FIG. 6). The impact of the amount of data used to train the scoring models can be examined by analyzing the correlation between the total amount (rather than percentage) of available training data exploited and zᵣ. This correlation was calculated to be 0.47. However, because the number of cases is small (14), this correlation cannot be said to be greater than 0 at p<0.05 (for N=14 the correlation has to be greater than 0.53 in order to be statistically significantly greater than 0).

A set of “ideal” features for each case is selected by applying linear regression to all the data. The rationale behind this is to discover the degree of improvement in performance of the rating methods that could be obtained by selecting the best set of features. It was observed that the (weighted) average r increases to 0.49 (Δr=0.02) using this approach, although this difference is not statistically significant. The case for which performance improves most when the best set of features is selected is the one for which there is the least amount of training data (case 5124, which has around 200 training samples). This suggests that it is not necessary to optimize the set of features any further, apart from in those cases where little data is available.

Intuitively, it may be thought that the presence of certain pairs of features in the same note should be penalized. For example, xray and CT should not be used together (due to concern of over exposure of the patient to ionized radiation), although the occurrence of either xray or CT would be acceptable. To capture this, from any two features (A and B), we produced three derivative features F₁=A and B, F₂=A or B, F₃=A x or B, and investigated their effect on the correlation coefficients. The results indicate that the derivative features do not have any effect on the final r across the 14 cases.

For workflow management, it will be useful to predict r (or zᵣ) before any human intervention in the selection of features and acceptable evidence. Analysis of the outputs of different raters was used to determine whether the r produced by CAPTNS alone can be used to predict the final r. It was noted that the zᵣ produced by C and zᵣ produced by W+F+P are highly correlated (r=0.91). This finding has a practical application: before asking human experts to review the feature list, linear regression exploiting all the features suggested by CAPTNS can be used to predict the final zᵣ using the formula: zᵣ_{_{—}}_{predicted}=0.35+0.57*zᵣ(C), in which zᵣ(C) is the z value of r given by linear regression on features produced by CAPTNS alone. It can be decided that the cost of human experts to review the list is economical if |zᵣ(C)|>t, for some threshold t, for example.

The correlation between the number of features selected by the reviewers and the final r was also investigated. Correlations between zᵣ and the number of features selected by human experts were calculated: the results are presented in Table 3. Essentially, the results suggest that selection of a greater number of features occurring in Physical Examinations and Work Up segments is beneficial, whereas the number of History features selected is almost inconsequential. It should be noted that because these correlations are calculated for a small sample size (14), it cannot be said that these zᵣ are significantly different from zero at 95% confidence. The results also indicate that the number of expressions selected as acceptable evidence of the occurrence of a feature (represented by Line count) does not have any significant effect on the performance of the linear regression models.

TABLE 3
Correlations between zᵣ and the number of
features selected by human reviewers.

Number of selected features

| | | | | | | Line |
|---|---|---|---|---|---|---|
| Model | His | Phy | Diag | Wo | Total | count |
| C | −0.10 | 0.25 | −0.01 | 0.38 | 0.02 | −0.25 |
| F | 0.08 | 0.27 | 0.21 | 0.46 | 0.21 | −0.15 |
| W + F + P | −0.17 | 0.20 | −0.07 | 0.35 | −0.05 | −0.15 |

His: Number of History features. Phy: Number of Physical Examination features. Diag: Number of Differential Diagnoses features. Wo: Number of Work up features. Total: Total number of features. Line count: Total number of lines in the key files.

The results allow several observations to be made. Most important is that it is possible to build regression models that assign scores to patient notes whose correlation with scores assigned by human raters is comparable with that of other human raters, as long as humans are involved in the selection of important features and the acceptable evidence confirming the presence of those features. This is shown in the (weighted) average of r of the optimized setting (W+F+P) of 0.47, which is the same as the r between human raters. When using features suggested by CAPTNS alone (C), automatically, performance is worse than that of baseline methods (although not with statistical significance). This indicates that humans should remain key actors in computer-assisted scoring, and their role should be to indicate potentially important features that serve as the basis for scoring.

The next important observation is that, as shown in Table 2 (column 3), models built using only content features outperform those built using only word count (W). This indicates that the methodology is complementary to those based only on word counts, which is one of the main objectives of computer-assisted scoring. Nevertheless, when word counts are used in addition to content-related features, the results approach the correlations observed between human raters (see also row 8, table 2, which indicates that the difference between human raters' correlations and settings that do not use word count are statistically significant at p<0.1). This is not surprising, as word count also correlates with the amount of information contained in notes. Furthermore, the results show that raters may have a positive bias toward the length of a note, as opposed to its content.

The strength of this methodology is that the reasoning behind the scores is fully accountable and customizable. Human raters can easily modify the plain text CAPTNS key files used by the automatic scoring system.

Rather than calculate the mean r directly, we use Fisher's z transformation. This is the most appropriate way to calculate the average correlation coefficient. This is due to the fact that the sampling distribution of r is very skewed, especially when r>0.5. It should also be noted that it is possible to calculate the confidence interval of r in each case (which means that the difference can be assessed), thanks to Fisher's z transformation.

Referring to FIG. 7, a table of the results is shown. Correlation coefficients yielded using different settings. Settings' abbreviations can be found in Table 1. Other column headers are: Nₒ samples: total number of samples available for linear regressions, excluding one used in feature suggestions. Weights: the weight of each section as specified in the scoring guidelines (History, Physical examination, Differential diagnosis, Workups). Nₒ Features selected: The number of features selected by reviewers (History, Physical examination, Differential diagnosis, Workups). Hu: correlation coefficients between one specific human rater and others for the case. Nₒ notes: the number of notes that are not used to produce the suggested features lists. Nₒ SF: Number of ideal features selected. C, W, F, F+P, W+F, W+F+P, Hu, Hi, SF: see, for example, Table 1

The analysis of the correlations between zᵣ and other factors such as the amount of available data, the number of features selected by reviewers or the number of patterns (acceptable evidence) selected by reviewers suggests several interesting hypotheses, but adequate testing will require access to a larger sample of cases. The first is that the more training data that is available, the higher the level of zᵣ that can be obtained. In the current article, the obtained level of r=0.46 is not statistically significantly different from zero, given that N=14. The second hypothesis is that reviewers should prioritize selection of features of the WORKUP category (r=0.35), rather than selection of acceptable evidence of the occurrence of those features (r=−0.15). Increasing the number of cases (N) will lead to a better understanding of these correlations.

The new Step 2 CS patient note features a new component wherein examinees are asked to explicitly list the history and physical exam findings that support each diagnosis they list. This new section of patient note is called Data Interpretation (DI) and represents a segment of the larger clinical reasoning construct. The history and physical examination sections are grouped together under the Data Gathering (DG) component. The DI and DG sections have separate scoring rubrics and therefore raters produce two separate scores for each patient note.

Efforts to adapt/modify CAPTNS to accommodate the new patient note began immediately after the operational adoption. To address data in the new DI section where the supporting history and physical examination findings are presented, the same principle (splitting the texts into ngrams, finding similar ngrams, and grouping them together) described in the main document was applied. Nevertheless, due to the concise way information is commonly presented in the supporting findings sections, and the fact that these sections are considerably shorter than the History and Physical Examination sections within the DG component, the ngrams are collected using a specific method. Firstly, the text is split into chunks using a set of boundary markers that often signify the boundary of a fact in this section, including [; |, | and |/]. Then each chunk is treated as an ngram.

### Example:

Supporting Hx: “HTN, borderline cholesterol, alcohol intake”

Supporting Ngrams: “HTN”, “borderline cholesterol”, “alcohol intake”.

For each diagnosis, in order to be suggested as potential supporting evidence, an ngram has to be present in the supporting evidence section of that same diagnosis in more than one note. This threshold is determined using empirical observations, and could be modified if needed. Similar ngrams are collected using the same method in other sections of the note.

With regard to the marking of supporting evidence, in addition to noting “yes” or “no” as the presence or absence of supporting evidence, CAPTNS is also able to return a number to indicate how many supporting pieces of information are presented for a given diagnosis.

One or more of the steps described herein can be implemented as instructions performed by a computer system. The instructions may be embodied in a non-transitory computer readable medium such as a hard drive, solid-state memory device, or computer disk. Suitable computers and computer readable media will be understood by one of skill in the art from the description herein.

Referring to FIG. 8, a system 80 for carrying out the above described methods in accordance with one embodiment is shown. The system 80 includes an output 806, an input 804, a memory 802, and processor 800 coupled to the memory 802, input 804, and output 806. The output 806 may be configured for outputting information, such as files, data, scores, selection interfaces, etc., to a user. The input 804 may be configured for inputting information, such as samples or sets of patient notes, scores, selections, etc., from a user or the processor 800.

Memory 802 stores information for system 80. For example, memory 802 stores data comprising information to be outputted with the output 806. Memory 802 may further store data comprising patient notes, scores, features, evidence, selections, etc. Suitable memory components for use as memory 802 will be known to one of ordinary skill in the art from the description herein.

Processor 800 controls the operation of system 80. Processor 800 is operable to control the information outputted on the output 806. Processor 800 is further operable to store and access data in memory 802. In particular, processor 800 may be programmed to implement one or more of the methods for scoring patient notes and/or generating scoring models for patient notes described herein.

It will be understood that system 80 is not limited to the above components, but may include alternative components and additional components, as would be understood by one of ordinary skill in the art from the description herein. For example, processor 800 may include multiple processors, e.g., a first processor for controlling information outputted on the output 806 and a second processor for controlling storage and access of data in memory 802.

Although aspects of the invention are illustrated and described herein with reference to specific embodiments, the invention is not intended to be limited to the details shown. Rather, various modifications may be made in the details within the scope and range of equivalents of the claims and without departing from the invention.

What is claimed:

1. A method of generating a model for scoring patient notes, comprising the steps of:
receiving a sample of patient notes;
extracting, by a processor, a plurality of ngrams from the sample of patient notes;
clustering, by a processor, the plurality of extracted ngrams that meet a similarity threshold into a plurality of lists;
identifying, by a processor, a feature associated with each of the plurality of lists based on the ngrams in that list;
designating at least one ngram in each list as evidence of the feature associated with that list; and
storing the identified features and designated ngram in a model for scoring patient notes.

2. The method of claim 1, further comprising the step of receiving a selection of evidence that is acceptable to indicate the feature associated with each list.

3. The method of claim 2, further comprising the step of determining, by a processor, whether the selected acceptable evidence is present in a set of patient notes.

4. The method of claim 1, further comprising the step of determining, by a processor, whether at least one associated feature is present in a set of patient notes.

5. The method of claim 1, wherein the similarity threshold comprises a predefined word edit distance.

6. The method of claim 5, wherein the predefined word edit distance is calculated by at least one of character-based edit distance or Wordnet edit distance.

7. The method of claim 5, wherein the predefined word edit distance is calculated by a Unified Medical Language System edit distance algorithm.

8. The method of claim 1, wherein the similarity threshold is calculated using concept unique identifiers associated with each of the plurality of ngrams.

9. The method of claim 1, wherein the feature associated with each list is identified by an ngram that occurs most frequently within each list.

10. The method of claim 1, further comprising the steps of:
analyzing, by a processor, each patient note in a set of patient notes to identify the presence of at least one feature;
determining, by a processor, whether at least one piece of evidence is present in each patient note; and
scoring each patient note in the set of patient notes based upon the identified presence of the at least one feature and the determined presence of the at least one piece of evidence.

11. A method of scoring patient notes, comprising the steps of:
producing, by a processor, a scoring model based on at least one feature and acceptable evidence that indicates the at least one feature in a patient note;
determining, by a processor, for each patient note in a set of patient notes, whether at least one piece of acceptable evidence that indicates the at least one feature is present in each patient note; and
scoring each patient note in the set of patient notes based upon the determined presence of acceptable evidence in each patient note.

12. The method of claim 11, further comprising the step of receiving a selection of acceptable evidence, selected from a list of evidence, that is acceptable to indicate the at least one feature with which the list of evidence is associated.

13. The method of claim 12, wherein the acceptable evidence is at least one ngram associated with the at least one feature.

14. The method of claim 11, wherein the at least one piece of evidence includes at least one of abbreviations, specialized medical terms, or typographical errors.

15. The method of claim 11, further comprising the steps of:
outputting a file that includes the set of patient notes in a vector of binary values;
wherein the vector of binary values indicates whether or not the at least one feature was identified to be present in each patient note in the set of patient notes.

16. The method of claim 11, wherein the at least one feature is identified to be present based on an exact match.

17. The method of claim 11, wherein the at least one feature is identified to be present based on a fuzzy match.

18. The method of claim 11, wherein the at least one piece of selected acceptable evidence is determined to be presented based on an exact match.

19. The method of claim 11, wherein the at least one piece of selected acceptable evidence is determined to be present based on a fuzzy match.

20. The method of claim 11, wherein the determining step is performed by:
extracting, by a processor, a plurality of ngrams from each patient note in the set of patient notes; and
determining whether the extracted ngrams match the acceptable evidence.
